(19) United States
(12) Patent Application Publication
(10) Pub. No.: US 2015/0282080 A1
(43) Pub. Date: Oct. 1, 2015

(54) SYSTEM, DEVICE, AND METHOD FOR CONFIGURING DUAL DRX CYCLES

(71) Applicant: BROADCOM CORPORATION, Irvine, CA (US)

(72) Inventors: Helka-Liina MAATTANEN, Helsinki (FI); Tao CHEN, Espoo (FI); Jussi OJALA, Helsinki (FI)

(73) Assignee: BROADCOM CORPORATION, Irvine, CA (US)

(21) Appl. No.: 14/673,439

(22) Filed: Mar. 30, 2015

Related U.S. Application Data
(60) Provisional application No. 61/971,695, filed on Mar. 28, 2014.

(51) Int. Cl. H04W 52/02; H04W 76/04

(52) U.S. Cl. CPC H04W 52/0216; H04W 52/0235; H04W 76/048

(57) ABSTRACT

A device includes circuitry configured to receive discontinuous reception (DRX) configuration parameters for at least one cell. The circuitry is also configured to determine that the at least one cell is in an ON state or an OFF state. A device-specific DRX cycle or a common DRX cycle is activated corresponding to the DRX configuration parameters based on the at least cell being in the ON state or the OFF state.

### CROSS-REFERENCE TO RELATED PATENT APPLICATIONS

The present application claims the benefit of the earlier filing date of U.S. provisional application 61/971,695 having common inventorship with the present application and filed in the U.S. Patent and Trademark Office on Mar. 28, 2014, the entire contents of which being incorporated herein by reference.

### BACKGROUND

1. Technical Field

The exemplary and non-limiting embodiments of this disclosure relate to wireless communication systems, methods, devices and computer programs. More specifically, the disclosure relates to configuring user equipment (UE) with multiple discontinuous reception (DRX) cycles and switching among those cycles, particularly those UEs operating in or near a small cell having the capability of being switched ON and OFF, where in the OFF state the cell operates with a discontinuous transmission (DTX) cycle.

2. Description of the Related Art

In the Third Generation Partnership Project (3GPP) for evolved UMTS Terrestrial Radio Access Network (E-UTRAN), heterogeneous networks can have small cells (pico or micro cells) dispersed within the coverage area of a relatively larger cell (macro cell). One area of research involves using discontinuous transmission (DTX) periods for the small cells. The DTX cells may have the ability to be discovered so they can be turned on for traffic offloading or handover purposes.

In some implementations, the small cell may be turned OFF if the network does not need it for capacity boosting, or especially if there are no UEs connected to it. While sleeping, the cell would send a discovery signal to enable detection of itself by UEs, and thus enabling a traffic based wake up. This ON/OFF operation of the small cells may be used in a single carrier mode where a UE is connected to one small cell or one macro cell at a time, or in a multicarrier mode where the small cell serves as an additional carrier to the UE via carrier aggregation (CA) or dual connectivity. To operate in single carrier mode the discovery signal supports UE mobility at least from the macro cell to the small cell because otherwise the whole small cell layer would only serve as an additional carrier or connection for CA or dual connection-capable UEs.

Document R1-135539 of the 3GPP TSG RAN WG1 Meeting #75 and document R1-134374 of the 3GPP TSG RAN WG1 Meeting #74 describe that during single carrier operations, the UE remains connected to the small cell when the small cell is in an OFF state. The UE can then be configured with a DRX cycle having the same periodicity as the discovery signal of the cell. The connection of the UE with the small cell can also be released when the small cell is in the OFF state, or a handover can be made to the macro cell or to another small cell. Configuring the UEs with DRX cycles enables faster serving of a UE from a small cell. For example, if the connection is released for a UE, that same UE may be able to reconnect to the small cell layer only after first establishing a connection to the macro cell and then via handover to the small cell layer. Such a handover can take more time than if the UE is configured with DRX in the OFF state cell. DRX operations are such that a cell can configure each UE with its own DRX cycle where the ON durations of the DRX cycles for different UE's are distributed in time. This time staggering helps prevent all of the UEs configured for DRX from sending uplink signals at the same time.

Details of conventional DRX operations may be seen in Release 11 of the 3GPP standard, for example, at sections 4.2.1, 4.4, and 5.6.9 of 3GPP TS 36.3331 Radio Resource Control (RRC) Protocol Specification; and at sections 3.1, 5.7, and 6.1.3 of 3GPP TS 36.321 Medium Access Control (MAC) Protocol Specification.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exemplary illustration of a heterogeneous radio system, according to certain embodiments;

FIG. 2A is an exemplary illustration of a DRX timing diagram for a UE, according to certain embodiments;

FIG. 2B is an exemplary illustration of common and UE-specific DRX cycles for UEs, according to certain embodiments;

FIG. 3 is an exemplary flowchart of a DRX control process, according to certain embodiments;

FIG. 4 is an exemplary list of Logical Control ID values for MAC commands, according to certain embodiments; and

FIG. 5 illustrates a non-limiting example of a UE, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “about,” and similar terms generally refer to ranges that include the identified value within a margin of 20%, 10%, or preferably 5%, and any values therebetween.

Aspects of this disclosure are directed to a UE operating with dual connectivity in a E-UTRAN network. The embodiments described herein are merely exemplary and are not meant to limit the scope of the disclosure. For example, the disclosure is directed to a UE within a coverage area of a macro cell with one more additional small cells operating within the macro cell coverage area, but the implementations described herein can also be applied to other types of networks. In addition, the embodiments described herein can also be applied to other types of wireless systems and radio access technologies, including UTRAN, LTE-Advanced (LTE-A), and High Speed Packet Access (HSPA), and the like. Embodiments of these teachings address how a dual-connected UE can most effectively use available transmit power to transmit simultaneous pending transmissions.

In an exemplary embodiment, a device includes circuitry configured to receive discontinuous reception (DRX) configuration parameters from an E-UTRAN Node B (eNB) for at least one cell. The circuitry is also configured to determine that the at least one cell is in an ON state or an OFF state. A device-specific DRX cycle or a common DRX cycle is activated corresponding to the DRX configuration parameters based on the at least cell being in the ON state or the OFF state.

In another exemplary embodiment, a method includes receiving discontinuous reception (DRX) configuration parameters from an E-UTRAN Node B (eNB) for at least one cell; determining that the at least one cell is in an ON state or an OFF state; and activating a device-specific DRX cycle or a common DRX cycle corresponding to the DRX configuration parameters based on the at least cell being in the ON state or the OFF state.

In another exemplary embodiment, a system includes at least one eNB corresponding to at least one cell configured to transmit DRX configuration parameters to at least one device based on an ON state or an OFF state of the at least one cell. The system also includes at least one device with circuitry configured to receive discontinuous reception (DRX) configuration parameters from an E-UTRAN Node B (eNB) for at least one cell; determine that the at least one cell is in an ON state or an OFF state; and activate a device-specific DRX cycle or a common DRX cycle corresponding to the DRX configuration parameters based on the at least cell being in the ON state or the OFF state.

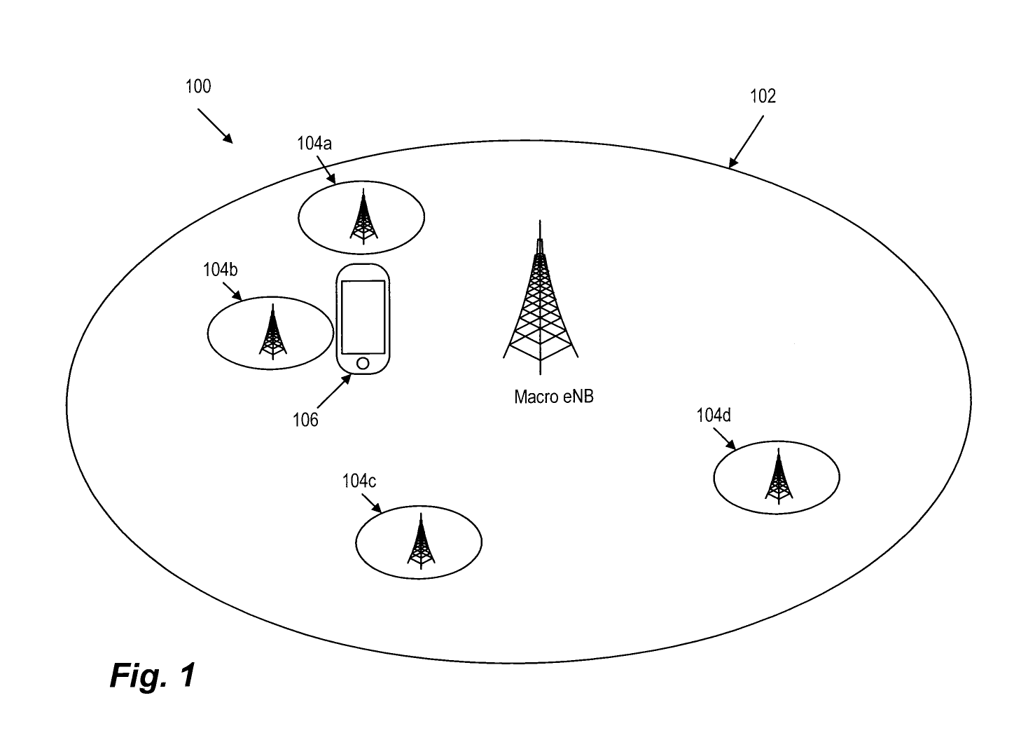

FIG. 1 is an exemplary illustration of a heterogeneous radio environment 100, according to certain embodiments. The radio environment 100 is a system including a macro cell served by a macro E-UTRAN Node Bs (eNodeBs or eNBs) 102 operates at a first frequency (f1) while one or more small cells served by small eNBs 104a, 104b, 104c, and 104d are dispersed throughout the macro cell coverage area and are operate at a second frequency (f2). The small eNBs 104a, 104b, 104c, and 104d can be pico cells and/or micro cells according to some implementations. The respective coverage areas for the macro eNB 102 and small eNBs 104a, 104b, 104c, and 104d are shown in FIG. 1 by ovals surrounding the eNBs. The frequency layers f1 and f2 can represent component carriers of a CA system for allocation of bandwidth in the radio system. According to some embodiments, the one or more pico eNBs can operate with DTX. FIG. 1 also shows one UE 106 operating within the heterogeneous radio environment although a plurality of UEs can operate within the macro cell coverage area at any given time.

In certain embodiments, the UE 106 is a device that can include, but is not limited to personal portable digital devices having wireless communication capabilities, such as cellular and other mobile phones including smartphones, navigation devices, laptop/palmtop/tablet computers, digital cameras and music devices, Internet appliances, USB dongles and data cards. Such portable digital devices may be implemented as radio communications handsets, wearable radio communications terminals, implanted radio communications terminals, and/or combinations of these. As will be discussed further herein, the UE 106 communicates wirelessly with the macro eNB 102 and the small eNBs 104a, 104b, 104c, and 104d.

In certain embodiments, from a perspective of the UE 106, the radio environment 100 performs single carrier operations where the UE 106 has one connection and one carrier (f1 or f2 in FIG. 1). In other embodiments the radio environment 100 is characterized by using CA where the UE 106 is configured simultaneously with a primary carrier and a secondary carrier (for example, f1 and f2), and the discontinuous reception (DRX) cycles described herein are for the secondary carrier. In other embodiments, the UE 106 is configured for dual connectivity in that the UE 106 has a plurality of radio-frequency (RF) chains that can simultaneously communicate on different frequencies. In the case of dual connectivity, the UE 106 can have two or more connections and the common DRX cycle described herein is for a secondary connection. In addition, when the UE 106 is configured for dual carrier operations, the dual UE connections can have a common DRX cycle on different component carriers, and the common DRX cycle can be applied to one or both carriers.

The ON/OFF DTX operation for the small cells means allows a small cell to be turned OFF if the radio network does not need it for capacity boosting or if there are the UE 106 is not connected to it. During any given OFF period, the small cell sends a discovery signal for radio resource management (RRM) measurement (e.g., Reference Signal Received Power (RSRP), Radio Reference Received Quality (RSRQ)) in order to support the UE's cell search for OFF cells. In addition, an OFF cell can be woken up so that the small cell can provision services to the UE 106 after the small cell transitions to the ON state. Throughout the disclosure, reference is made to the DRX configuration of the UE 106 with respect to at least one small cell, however, the processes described herein can also be implemented with respect to macro cells.

In some implementations, discovery burst transmissions among the OFF signals can be time-aligned. The discovery burst, also referred to as a discovery reference signal, can include a primary synchronization signal (PSS), a secondary synchronization signal (SSS) and a common reference signal (CRS). In some implementations, the PSS is used for symbol timing and physical-layer identifier (ID) detection as well as for frequency offset compensation after estimation. The SSS is used for cyclic prefix detection, cell group ID detection and 10 millisecond (ms) radio frame timing detection. The Cell ID of the cell that sent the discovery signal can be determined by processing circuitry of the receiving UE 106 based on the physical-layer ID and the cell group ID. After cell detection, the UE 106 can measure link strength as a RSRP value from resource elements (REs) that carry the common reference signals (CRSs).

In some implementations, the discovery burst allows the UE 106, attached to the macro cell on f1, to perform an inter-frequency cell search on f2 regardless of the small cell's ON/OFF operation. Typically the CRS is transmitted at each subframe of the discovery burst while the PSS and SSS are transmitted in a smaller number of subframes of the discovery burst. According to one implementation, the discovery burst is 6 subframes in length. In other implementations, the discovery burst can have a greater or smaller number of subframes. In addition, time aligning the small cell discovery bursts can reduce the cell search time by capturing all DTX small cells within one UE detection interval. In addition, time domain radio resources can be saved by avoiding the use too many UE measurement gaps (intervals during which the UE 106 is allowed to be monitoring frequency f2) for the UE's inter-frequency cell search.

When the discovery bursts sent by the small cells are time-aligned, a common DRX cycle can be used for more than one UE 106 regardless of a size of the coverage areas of the small cells in closest proximity to the UEs. In certain embodiments, the macro cell and/or sub cells broadcast common DRX parameters to configure the UEs within or near the coverage areas for common DRX cycles. For example, the small cells can broadcast the common DRX parameters to the UEs when clusters of small cells time-align their discovery signals rather than being governed by the time alignment of the macro cell coverage area. Details regarding the common DRX cycles are discussed further herein.

In some embodiments, the discovery signal sent by the small cells may have a periodicity that is unequal to the periodicity of a legacy signal or has a different pattern than the legacy signal. The legacy signals are signals sent by the small cell when in an ON state. In some implementations, the legacy signal structure has the PSS/SSS/CRS sent with 5 ms periodicity, and the discovery signals have a periodicity that is longer than the legacy signal periodicity. For example, the periodicity of the small cell's discovery signal could be 20 ms, 40 ms, 0 ms, or any other periodicity. In addition, the discovery signal can include a 5 ms burst with one PSS and SSS and with resource elements (REs) carrying the CRSs.

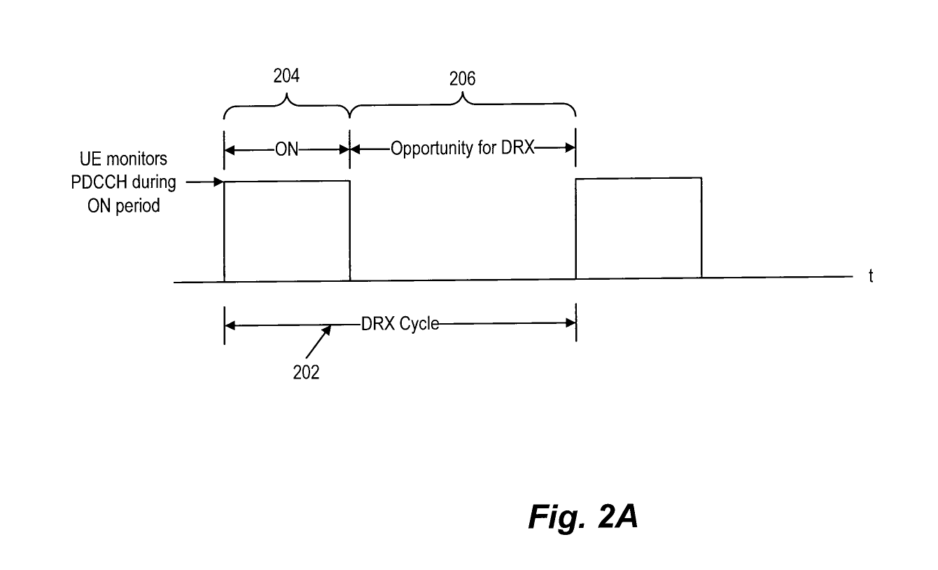

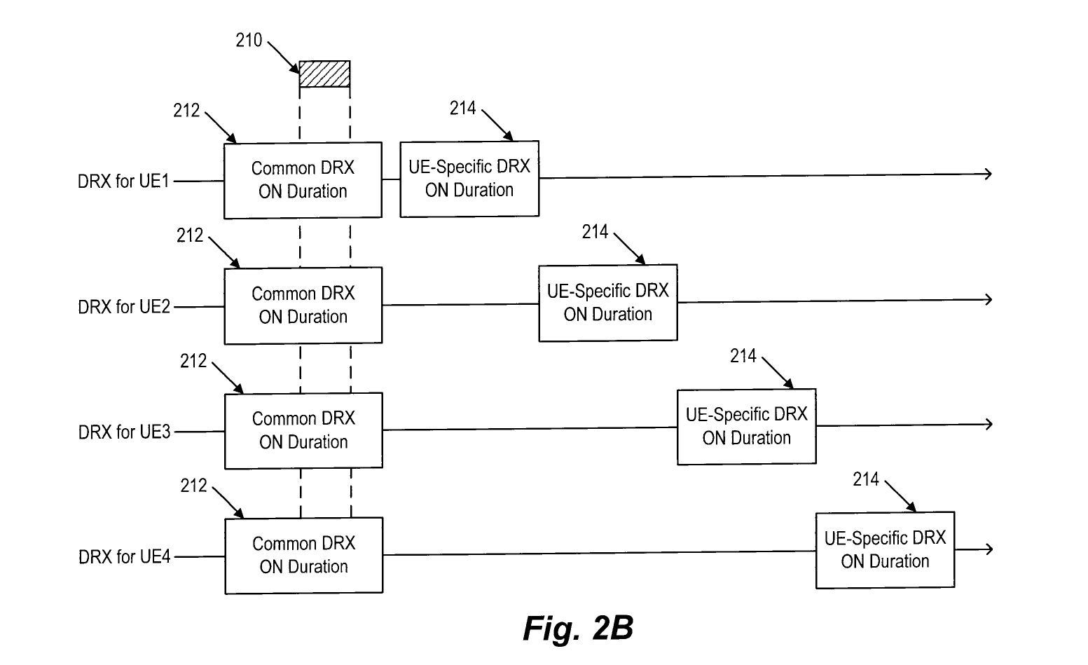

FIG. 2A is a DRX timing diagram for a UE 106, according to certain embodiments. Each DRX cycle 202 configured for the UE 106 has alternating ON durations 204 and OFF durations 206. The UE 106 is in receiving, or “listening”, state during the ON durations 204. If no ongoing data and/or other signaling process are being performed, the UE 106 can enter a reduced power state, referred to as “sleep,” for whatever period of time remains in the OFF duration 206 of the DRX cycle 202. The OFF duration 206 is referred as an “opportunity for DRX” in FIG. 2 since the UE 106 may not be in the sleep state if a data and/or signaling process is being performed. According to the implementations described further herein, the UE 106 can have both UE-specific DRX cycles and common DRX cycles that are shared with other UEs communicating with a common small cell.

According to certain embodiments, the UE 106 listens during the ON duration 204 for a physical downlink control channel (PDCCH). The eNBs of the macro cell and small cells use the PDCCHs to schedule uplink and downlink resources, such as physical uplink shared channels (PDSCHs) and physical downlink shared channels (PDSCHs), for exchanging data with the UEs scheduled by that PDCCH. If the UE 106 is not configured with a DRX cycle, or if the common and/or UE-specific DRX cycles are disabled, the UE 106 may not observe the ON and OFF durations of the disabled DRX cycles, and the UE 106 can receive permission to transition to the sleep state during the OFF duration 206. As will be described further herein, the UE 106 may still observe the ON and OFF durations of another configured DRX cycle that is not disabled.

The DTX cycle of a small cell can be defined using terminology that corresponds to the DRX cycle 202 of the UE 106. Like the DRX cycle 202 of the UE 106 the DTX cycle of the small cell has alternating ON durations and OFF durations, and the discovery signals are sent within the DTX ON durations. In some implementations, the OFF durations of the DTX cycle correspond to a low power state for the small cell. The cell can enter a low power state during whatever remains of the OFF duration so long as there are no ongoing data exchanges or other signaling carried over from the previous ON duration. The DTX cycles for the small cells can be implemented when the small cell is OFF. When the small cell is ON, the small cell operates continuously. Throughout the disclosure, the status of the cell is referred to as ON or OFF which is different than the ON durations and OFF durations of the DRX and DTX cycles.

Throughout the disclosure, the discovery signal of the small cell is transmitted in a 5 ms burst (that is, across 5 LTE subframes) and carries a PSS, a SSS, and at least one CRS. According to certain embodiments, the small cell discovery signal has the PSS and SSS in adjacent symbol positions while the CRSs of the discovery signal are on different resource elements within the burst. However, other discovery signal formats can also be implemented according to the embodiments described herein. In addition, the periodicity at which the discovery signals are transmitted can be at a reduced periodicity (that is, a longer time interval), such as 20 ms or 40 ms. A common DRX cycle can be configured among more than one UE 106 since the discovery signal periodicity may be fixed and/or changeable within a predetermined finite set of periodicities (such as integer multiples of the discovery burst duration).

According to certain embodiments, the UE-specific DRX cycle can be applied when the cell is in an ON state, and the common DRX cycle is a cell specific DRX cycle which can applied when the cell is in OFF state and sends discovery signals during the ON durations of the DTX cycle. The common DRX cycle may have a one-to-one correspondence with the DTX cycle where the common DTX cycle matches the discovery signal periodicity of the small cell, which means that the common DRX cycle for the UE 106 matches the DTX periodicity for the small cell. In some embodiments, the common DRX cycle ON durations may not correspond directly to the DTX ON durations. For example, at least one UE 106 can be configured with a common DRX cycle whose periodicity is an integer multiple of the small cell's DTX periodicity.

The UE-specific DRX cycle can be used when the small cell is ON and not operating according to a DTX cycle. In some implementations, unique discovery burst timing windows can be assigned to individual UEs so that the possible uplink reports of the UEs will appear at different times and different measurement occasions, thus avoiding congestion. Also, the UE 106 can read a PDCCH during each ON duration of its UE-specific DRX cycle in order to check whether there is a data transmission to receive or send. Having staggered ON durations for the UE-specific DRX cycles that do not overlap relaxes the scheduling restrictions on the scheduling eNB as compared to situations where only a common DRX cycle is used for the UEs.

When the cell OFF and thus operating under its DTX cycle, the UEs in the cell can wake up during the small cell's discovery burst durations, which is enabled by having the UEs configured with the common DRX cycle when the small cell is in an inactive state. In addition, having the ON duration of that common DRX cycle coincide in time with the ON duration of the small cell's DTX cycle enables the UEs in the cell to wake up during the small cell's discovery burst duration.

FIG. 2B is an exemplary illustration of common and UE-specific DRX cycles for UEs, according to certain embodiments. The UEs shown in FIG. 2B (UE1, UE2, UE3, and UE4) are exemplary implementations of the UE 106 and can operate at the same time within the macro cell for the macro eNB 102 shown in FIG. 1. If all the small cells 104a, 104b, 104c and 104d operate with synchronized DTX cycles, then the UEs can be connected to any of the small cells. For embodiments where small cell clusters operate with synchronized DTX cycles, then the UEs can operate within or within close proximity to, the small cell cluster having synchronized DTX cycles. For example, a small cell cluster may include small cells 104a and 104b in FIG. 1. For each UE, one of the DRX cycles is active at a given time, and each UE has at any given time either the UE-specific DRX cycle active or the common DRX cycle active.

The timing diagram shown in FIG. 2B spans one DRX cycle, regardless of whether the DRX cycle is UE-specific or common. When the common DRX cycle 212 is in effect, meaning that the small cells in the macro cell coverage area and/or small cell cluster are in OFF with the synchronized DTX cycles active, the ON duration for each UE DRX cycle is illustrated as the common DRX ON duration 212, and the remainder of the time corresponds to the common DRX OFF duration. This common DRX ON duration 212 coincides in time with the discovery burst 210 of the small cells in the small cell cluster when the small cell transmits the discovery signal with the PSS, SSS, and one or more CRSs.

When the UE-specific DRX cycles are active, meaning that the small cells within the macro cell coverage area and/or small cell cluster are in the ON state and operating continuously, the ON duration for each UE is illustrated as the UE-specific ON duration 214 and the remainder of the time is the UE-specific DRX OFF duration. The staggered, non-overlapping UE-specific DRX ON durations are distributed in time to reduce uplink interference when the UEs have uplink measurement reports or other signaling data to send.

While the small cell is in the ON state it may also send discovery bursts (not shown) so that other UEs in the area not yet connected to the small cell can discover and measure the small cell. According to certain embodiments, there can be differences between the discovery bursts sent from the small cell in the ON state as compared to the discovery bursts sent from the small cell in the OFF state. For example, the OFF state discovery burst signal can have common reference signals not present in the ON state discovery signals so that the UEs themselves can distinguish small cell is in the ON and OFF states. The processing circuitry of the UEs can recognize the differences in the discovery signals as a command to disable one of the common or UE-specific DRX cycles while enabling the other.

For example, when the UE 106 sees a discovery signal from a small cell with a CRS, the processing circuitry of the UE 106 can determine that the small cell is in the OFF state, and the UE 106 disables the UE-specific DRX cycle and enables the common DRX cycle. In addition, when the UE 106 sees a discovery signal from the small cell as not having a CRS, the processing circuitry of the UE 106 can determine that the small cell is in the ON state, and the UE 106 disables the common DRX cycle and enables the UE-specific DRX cycle.

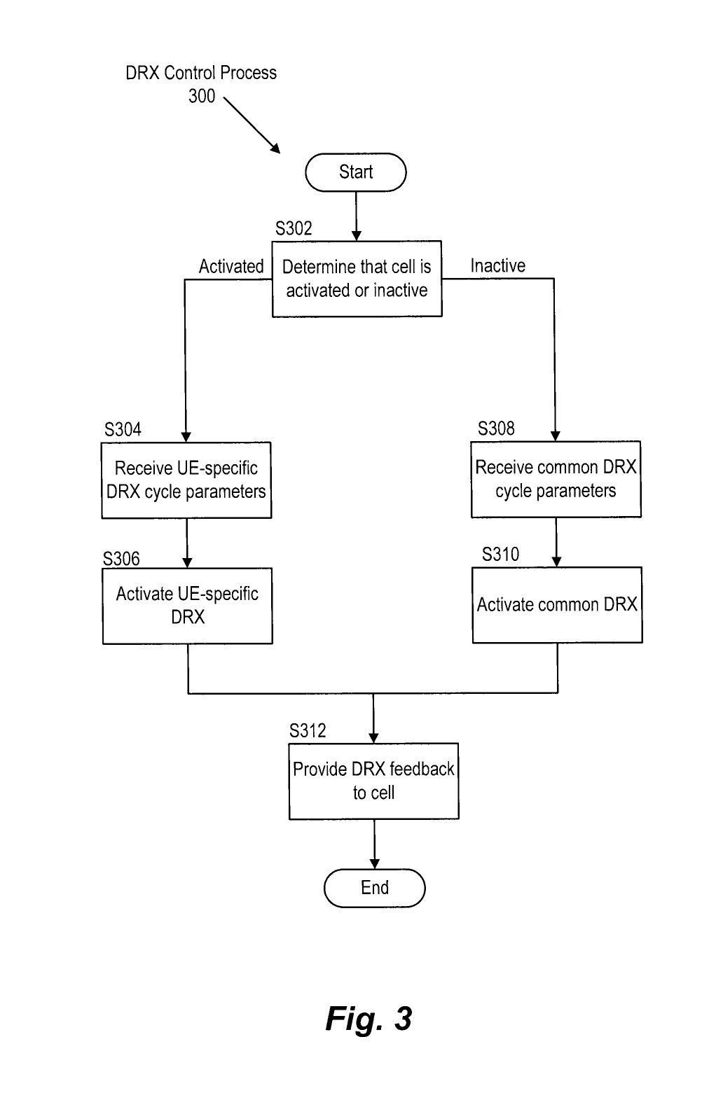

FIG. 3 is an exemplary flowchart of a DRX control process 300, according to certain embodiments. Based on whether the at least one small cell to which the UE 106 is connected is in the ON state of the OFF state, the UE 106 can implement a UE-specific DRX cycle or a common DRX cycle. In some implementations, the UE 106 can implement UE-specific DRX cycles where the ON durations are staggered in time relative to one another. In addition, the UE 106 can implement common DRX cycles where all UE's connected to the at least one small cell search for discovery signals for the small cell at corresponding time intervals. The embodiments described by the DRX control process 300 illustrate that the UE 106 can switch between the UE-specific DRX cycle and the common DRX cycle to efficiently use the ON durations of the DRX cycles for the UE 106.

At step S302, the processing circuitry of the UE 106 determines whether the at least one small cell to which the UE 106 is connected is in an ON or OFF state. For example, when the at least one small cell is the ON state, the small cell operates continuously. When in the OFF state, the at least one small cell operates according to the DTX cycle and transmits discovery burst signals during the ON duration of the DTX cycle. If the UE 106 determines that the at least one small cell is in the ON state, then step S304 is performed. Otherwise, if the UE 106 determines that the at least one small cell is in the OFF state, then step S308 is performed. In addition, the processing circuitry can also determine that the small cell is going to switch from the ON to the OFF state or from the OFF to the ON state based on the types of signals transmitted to the UE 106. For example, if the small cell is in the ON state and sends configuration parameters for a common DRX cycle to the UE 106, the processing circuitry of the UE 106 can determine that the small cell is about to enter the OFF state.

At step S304, if the UE 106 determines that the at least one small cell is in the ON state or is preparing to enter the ON state, then the UE 106 receives configuration parameters for the UE-specific DRX. In one implementation, the UE 106 receives RCC or broadcast signaling from the small cell that includes the UE-specific DRX parameters. In other embodiments, the UE 106 can access the DRX configuration parameters from a previously implemented UE-specific DRX. For example, the UE-specific DRX configuration parameters received by the UE 106 can include start and stop timing information for the staggered UE DRX ON durations. Section 5.7 of 3GPP TS 36.321, V11.5.0 describes the configuration parameters for the UE-specific DRX cycles.

At step S306, the UE 106 activates the UE-specific DRX cycles. In one embodiment the UE 106 receives an explicit signal from the small cell to activate the UE-specific DRX cycle. In some implementations, the UE 106 can activate and/or deactivate the common and UE-specific DRX cycles based on the content of the discovery signals received from the small cell and without explicit signaling. For example, the UE 106 can determine that the UE-specific DRX cycle is to be activated when the UE 106 recognizes that the discovery signal transmitted by the small does not carry CRSs. In addition, the activation and/or deactivation of the UE-specific DRX cycle can be based on the presence or absence of other types of reference signals such as channel state indication reference signal CSI-RS or positioning reference signal PRS.

According to certain embodiments, a medium access control (MAC) or physical layer signal can be defined to enable the UE-specific DRX for the UE 106. For example, for small cells with faster response times than other small cells, physical layer signals can send a cell-DRX-RNTI (radio network temporary identifier) to one or more UEs to enable the UE-specific DRX. The UE-specific DRX cycle can be implemented in the UE 106 with or without prior data related to previous UE-specific DRX operations. For example, upon receiving a command to enable UE-specific DRX operations and disable common DRX operations, a previously suspended UE-specific DRX cycle can be resumed automatically and/or after a predetermined amount of time has passed and can be controlled by a resumingTimer parameter within the UE 106. A new UE-specific DRX can also be configured for the UE 106 via RRC signaling.

At step S308, if the UE 106 determines that the at least one small cell if in the OFF state, then the UE 106 receives configuration parameters for the common DRX. In one implementation, the UE 106 receives RCC or broadcast signaling from the small cell that includes the common DRX parameters. For example, the common DRX configuration parameters can be configured via a broadcast system information block (SIB) message. Idle mode UEs can receive the common DRX configuration parameters via a page on the paging channel during the ON duration of the DRX cycle. In some implementations, one or more UEs can have different common DRX configuration parameters than other UEs as long as the DRX cycles are a multiple of the small cell's discovery burst signal cycle so that the ON durations of the common DRX cycles correspond to the discovery burst signals of the small cell.

One common DRX configuration parameter is a “Common DRX active Time,” which is the time during which the UE 106 monitors the PDCCH in PDCCH subframes. Another common DRX configuration parameters is a “Common DRX Cycle,” specifies the periodic repetition of the ON duration followed by a possible period of inactivity as described previously with respect to FIG. 2B. “UE specific DRX-resumingTimer” is a common DRX configuration parameter that specifies a number of consecutive PDCCH-subframe(s) after the subframe carrying PDCCH/MAC after which the common DRX is disabled. For example, when a timer has expired and no data transmission occurs during the period, the suspended UE-specific DRX cycle can be resumed automatically. In addition, “Common drxStartOffset” specifies a subframe where the common DRX cycle starts.

At step S310, the UE activates the common DRX cycle. In one implementation, the UE 106 receives the configuration parameters for the common DRX cycle when the small cell is in the ON state, and the common DRX cycle is activated when the small cell switches to the OFF state. In another implementation, the UE 106 activates the common DRX cycle immediately after receiving the common DRX configuration parameters. In addition, activating the common DRX cycle may not mandate that the small cell immediately transition to the OFF state but may enable the UE 106 to stay connected to the small cell when the small cell transitions to the OFF state. When the common DRX is activated, the UEs that are connected to the small cell or cluster of small cells receive uplink and downlink resource grants (PDCCHs) for data transmission or indications of cell status change when the DTX cycle of the small cell is in the ON duration.

According to certain embodiments, MAC or physical layer signal can be defined to enable the common DRX for the UE 106. For example, for small cells with faster response times than other small cells, physical layer signals can send a cell-DRX-RNTI to one or more UEs to enable the common DRX. Upon receiving a command to enable common DRX operations, an existing UE-specific DRX cycle can be stopped and/or suspended.

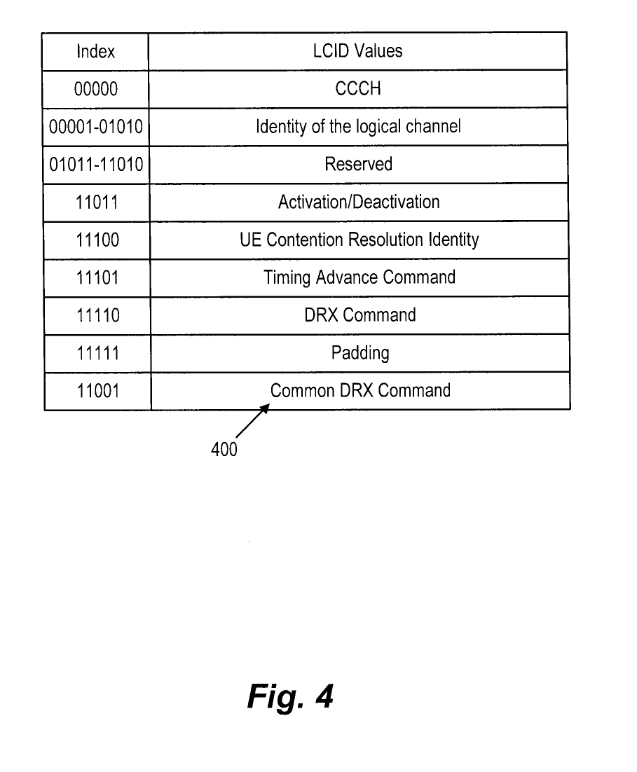

In addition, a new MAC command (or physical layer broadcasting signaling) can be added to include the common DRX activation MAC command. In one implementation, FIG. 4 is a modified version of Table 6.2.1-1 from 3GPP TS 36.321 that adds a last row 400 to include a binary MAC command to activate the common DRX cycle (and simultaneously deactivate the UE-specific DRX cycle). LCID in FIG. 4 is a Logical Channel ID field that identifies the type of corresponding MAC control element.

Referring back to FIG. 3, at step S312, the UE 106 provides feedback to the small cell regarding the UE-specific and/or common DRX activation to ensure that the UEs have correctly received the common DRX activation/deactivation commands. For example, the UE 106 can indicate that the UE 106 has received an activation command for a common DRX cycle by immediately ceasing to report channel state indication (CSI). If the eNB for the small cell continues to receive CSI reports from the UE 106 after sending the common DRX cycle activation command, then the eNB can determine that the common DRX cycle activation command has not been received and that the command should be resent. In addition, upon receiving a command to deactivate the common DRX cycle and activate the UE-specific DRX cycle, the UE 106 can immediately resume CSI reporting. If the eNB for the small cell continues to not receive CSI reports from the UE 106 after sending the UE-specific DRX cycle activation command, then the eNB can determine that the UE-specific DRX cycle activation command has not been received and that the command should be resent.

According to certain embodiments of the DRX control process 300, a RMM subset restriction can be associated with the common DRX configuration. In addition, the common DRX cycle can be configured so that RRM measurement occurrences are restricted to downlink subframes with active dedicated reference signal (DRS) transmissions. Also, if CSI reporting is allowed during the common DRX period, the CSI measurement subframe subset restriction associated with the common DRX configuration can be configured to ensure that CSI measurement is occurring in the downlink subframes with active reference signal (RS) transmission.

In some implementations, use of the DRX and/or DTX by the UE 106 and/or small cells is meant for long term operations but is to be used to prevent unnecessary connection releases or handovers between layers of a network. For example, a cell specific DRX timer can be implemented that defines a time at which the UE 106 transitions to an idle mode if there is no data to be transmitted to that UE 106 for a period of time.

Embodiments of these teachings address DRX operations for the UE 106 communicating with one or more small cells within the coverage area of a macro cell. By activating a UE-specific DRX cycle when the small cell is in an ON state and a common DRX cycle when the small cell is in an OFF state, the UE 106 can stay connected to the small cell when the small cell switches to an OFF state, which can improve speed of ON/OFF transitions for single carrier ON/OFF procedures. In addition, the embodiments described herein allow the UE 106 to indicate to the eNB for the small cells that the UE 106 has received the enablement and/or disablement commands for the UE-specific DRX cycle and common DRX cycle and allows for flexible interaction between UE-specific and common DRX operations. Some embodiments described herein have explicit signaling for enabling or disabling the UE-specific and common DRX operations. In other embodiments described herein, the processing circuitry of the UE 106 can determine that the small cell has entered an ON state or an OFF state based on the content of data sent from the small cell and without receiving explicit signaling.

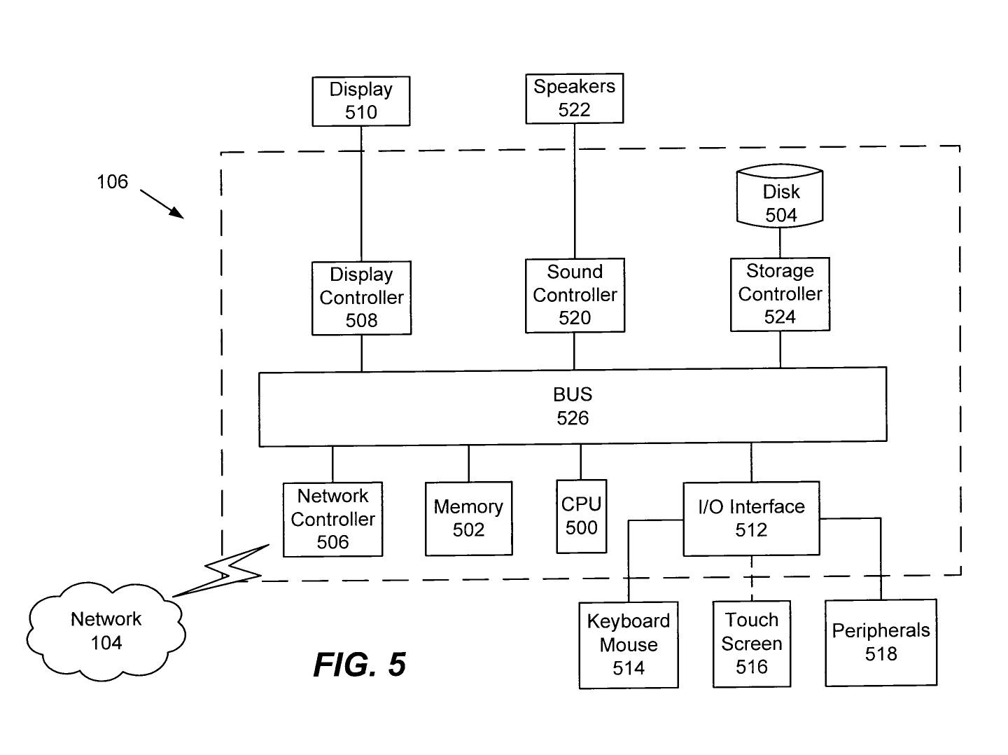

A hardware description of the UE 106 according to exemplary embodiments is described with reference to FIG. 5. In addition, the hardware described by FIG. 5 can also apply to the circuitry associated with the macro eNB 102, the small eNBs 104a, 104b, 104c, and 104d, and other higher level network entities associated with the MAC (L2) and network layer (L3). The UE 106 includes a CPU 500 that perform the processes described above/below. The process data and instructions may be stored in memory 502. These processes and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the UE 106 communicates, such as the MeNB 102 and/or the SeNB 104.

Further, the claimed advancements may be provided as a utility application, background daemon, or component of an operating system, or combination thereof, executing in conjunction with CPU 500 and an operating system such as Microsoft Windows 7, UNIX, Solaris, LINUX, Apple MAC-OS and other systems known to those skilled in the art.

The hardware elements in order to achieve the UE 106 may be realized by various circuitry elements, known to those skilled in the art. For example, CPU 500 may be a Xenon or Core processor from Intel of America or an Opteron processor from AMD of America, or may be other processor types that would be recognized by one of ordinary skill in the art. Alternatively, the CPU 500 may be implemented on an FPGA, ASIC, PLD or using discrete logic circuits, as one of ordinary skill in the art would recognize. Further, CPU 500 may be implemented as multiple processors cooperatively working in parallel to perform the instructions of the inventive processes described above.

The UE 106 in FIG. 5 also includes a network controller 506, such as an Intel Ethernet PRO network interface card from Intel Corporation of America, for interfacing with network 104. As can be appreciated, the network 104 can be any E-UTRAN/LTE network but can also be a public network, such as the Internet, or a private network such as an LAN or WAN network, or any combination thereof and can also include PSTN or ISDN sub-networks. The network 104 can also be wired, such as an Ethernet network, or can be wireless such as a cellular network including EDGE, 3G and 4G wireless cellular systems. The wireless network can also be Wi-Fi, Bluetooth, or any other wireless form of communication that is known. For example, the network 104 can include the radio environment 100 discussed previously herein.

In addition, while not particularly illustrated for the UE 106, macro eNB 102, and small eNBs 104a, 104b, 104c, and 104d, these devices can include a modem and/or a chipset and/or an antenna chip which may or may not be inbuilt onto a radiofrequency (RF) front end module within the respective host device. These devices can also include transmitter and receiver hardware for wireless communications between the UE 106, macro eNB 102, and small eNBs 104a, 104b, 104c, and 104d.

The UE 106 further includes a display controller 508, such as a NVIDIA GeForce GTX or Quadro graphics adaptor from NVIDIA Corporation of America for interfacing with display 510 of the UE, such as a Hewlett Packard HPL2445w LCD monitor. A general purpose I/O interface 512 at the UE 106 interfaces with a keyboard and/or mouse 514 as well as a touch screen panel 516 on or separate from display 510. General purpose I/O interface 512 also connects to a variety of peripherals 518 including printers and scanners, such as an OfficeJet or DeskJet from Hewlett Packard.

A sound controller 520 is also provided in the UE 106, such as Sound Blaster X-Fi Titanium from Creative, to interface with speakers/microphone 522 thereby providing sounds and/or music.

The general purpose storage controller 524 connects the storage medium disk 704 with communication bus 526, which may be an ISA, EISA, VESA, PCI, or similar, for interconnecting all of the components of the UE 106. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

In other alternate embodiments, processing features according to the present disclosure may be implemented and commercialized as hardware, a software solution, or a combination thereof. Moreover, instructions corresponding to the DRX control process 300 in accordance with the present disclosure could be stored in a thumb drive that hosts a secure process.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, an implementation may be performed on modules or hardware not identical to those described. Accordingly, other implementations are within the scope that may be claimed.

1. A device comprising:
circuitry configured to
receive discontinuous reception (DRX) configuration parameters for at least one cell;
determine that the at least one cell is in an ON state or an OFF state; and
activate a device-specific DRX cycle or a common DRX cycle corresponding to the DRX configuration parameters based on the at least cell being in the ON state or the OFF state.

2. The device of claim 1, wherein
the at least one cell includes at least one small cell operating within a coverage area of a macro cell.

3. The device of claim 1, wherein
the circuitry is configured to receive the DRX configuration parameters via broadcast signals from an E-UTRAN Node B (eNB).

4. The device of claim 1, wherein
the circuitry is configured to activate the device-specific DRX cycle when the at least one cell is in the ON state.

5. The device of claim 4, wherein
the device-specific DRX cycle has an ON duration that does not overlap with the ON durations of DRX cycles for one or more other devices.

6. The device of claim 4, wherein
the circuitry is configured to activate the device-specific DRX cycle when a common reference signal (CRS) is absent from a discovery burst signal for the at least one cell.

7. The device of claim 4, wherein
the circuitry is configured to activate the device-specific DRX cycle based on a previously suspended device-specific DRX cycle.

8. The device of claim 4, wherein
the circuitry is further configured to output channel state indication (CSI) reports after receiving a device-specific DRX activation command from the eNB.

9. The device of claim 4, wherein
the circuitry is configured to activate the device-specific DRX cycle when a predetermined amount of time has passed without an occurrence of a data transmission.

10. The device of claim 1, wherein
the circuitry is configured to activate the common DRX cycle when the serving cell is in the OFF state.

11. The device of claim 10, wherein
the circuitry is further configured to receive the configuration parameters for the common DRX cycle having an ON duration that corresponds to the ON durations of DRX cycles for one or more other devices.

12. The device of claim 10, wherein
the common DRX cycle has an ON duration that corresponds to an ON duration of a discontinuous transmission (DTX) cycle for the at least one cell.

13. The device of claim 11, wherein
the common DRX cycle has a periodicity that corresponds to an integer multiple of a periodicity for the DTX cycle of the at least one cell.

14. The device of claim 10, wherein
a periodicity of the common DRX cycle corresponds to a periodicity with which discovery burst signals are sent from the at least one cell.

15. The device of claim 10, wherein
the circuitry is further configured to activate the common DRX cycle based on a medium access control (MAC) command received from an E-UTRAN Node B (eNB).

16. The device of claim 10, wherein
the circuitry is configured to activate the common DRX cycle when a common reference signal (CRS) is present in a discovery burst signal for the at least one cell.

17. The device of claim 10, wherein
the circuitry is configured to cease output of channel state information (CSI) reports after receiving a common DRX activation command from an E-UTRAN Node B (eNB).

18. The device of claim 1, wherein
the circuitry is configured to activate the device-specific DRX cycle or the common DRX cycle based on a DRX radio network temporary identifier (RNTI) for the at least one cell.

19. A method comprising:
receiving, from a wireless network, a configuration for a device-specific discontinuous reception cycle and a configuration for a common discontinuous reception cycle; and
operating according to the device-specific discontinuous reception cycle or the common discontinuous reception cycle in response to signaling received from the wireless network.

20. A user equipment (UE) comprising:
circuitry configured to
receive, from a wireless network, a configuration for a UE-specific discontinuous reception (DRX) cycle and a configuration for a common DRX cycle; and
operate according to the UE-specific DRX cycle or the common DRX cycle in response to signaling received from the wireless network.
